(19) United States
(12) Patent Application Publication
(10) Pub. No.: US 2026/0371084 A1
(43) Pub. Date: Nov. 19, 2026

(54) METHOD AND APPARATUS FOR AVOIDING KEY MISMATCH IN CASE OF PARALLEL AUTHENTICATION

(71) Applicant: Nokia Technologies Oy, Espoo (FI)

(72) Inventors: Ranganathan MAVUREDDI DHANASEKARAN, Munich (DE); Saurabh KHARE, Bangalore (IN); Jing PING, Chengdu (CN); Sung Hwan WON, Dallas, TX (US)

(21) Appl. No.: 19/128,056

(22) PCT Filed: Nov. 7, 2022
(86) PCT No.: PCT/CN2022/130335

§ 371 Date: May 7, 2025

(51) Int. Cl. H04W 12/069; H04W 12/041

(52) U.S. Cl. CPC H04W 12/069; H04W 12/041

(57) ABSTRACT

Methods, apparatus and computer-readable medium are disclosed for avoiding key mismatch in case of parallel authentication. A method performed at a user equipment (UE), comprises, receiving from a network node, a request to perform an authentication with a home network (HN) of the UE on a first mobile communication network connection of the UE; determining whether there is another authentication being performed with the HN on a second mobile communication network connection for the UE or not; and when there is another authentication being performed with the HN on the second mobile communication network connection, delaying the authentication on the first mobile communication network connection or reject the request.

### TECHNICAL FIELD

Embodiments of the disclosure generally relate to security for a cellular communication terminal and a mobile communication network, and more particularly, to methods and apparatus for avoiding key mismatch between a cellular communication terminal and its home network in case of parallel authentication,

### BACKGROUND

Before initiating communication with a cellular communication network, such as a fifth generation (5G) system, a cellular communication terminal, also referred to as user equipment (UE), needs to have performed primary authentication and registered with its home public land mobile network (HPLMN). The primary authentication can enable mutual authentication between the UE and the HN, and provide keying material, including key K_{AUSF} and other keys derived from the K_{AUSF}, that can be used between the UE and the HPLMN (as well as a serving network of the UE) in subsequent security procedures. The key K_{AUSF} is established between the UE and the HPLMN from the primary authentication procedure. It is specified in protocols that the latest KAUSF result of a successful completion of the latest primary authentication shall be used by the UE and the HPLMN, regardless over which access network type (3GPP or non-3GPP) it was generated.

However, there still exists a possibility that, two separate security procedures are performed over two different non-access Stratum (NAS) connections between the UE and the HPLMN in parallel. Concurrent runs of the two separate security procedures in parallel may lead to race conditions and mismatches between security contexts in the UE and the HPLMN. The security contexts are created by primary authentication. In this scenario, it would be a problem which K_{AUSF} (from separate primary authentications for the two different NAS connections) is considered as the latest one in the HPLMN and the UE.

### SUMMARY

This summary is provided to introduce simplified concepts of the present disclosure. This summary is not intended to identify key features or essential features of the claimed subject matter, nor is it intended to be used to limit the scope of the claimed subject matter.

According to a first aspect of the disclosure, there is provided an apparatus at a user equipment (UE). The apparatus comprises at least one processor, and at least one memory storing instructions that, when executed on the at least one processor, cause the apparatus at least to receive from a network node, a request to perform an authentication with a home network (HN) of the UE on a first mobile communication network connection of the UE; determine whether there is another authentication being performed with the HN on a second mobile communication network connection for the UE or not; and when there is another authentication being performed with the HN on the second mobile communication network connection, delay the authentication on the first mobile communication network connection or reject the request.

According to a second aspect of the disclosure, there is provided an apparatus at a unified data management (UDM) node in a home network (HN) of a user equipment (UE). The apparatus comprises at least one processor, and at least one memory storing instructions that, when executed on the at least one processor, cause the apparatus at least to, receive from an authentication server function (AUSF) node, a request to fetch an authentication vector for an authentication between the HN and the UE on a first mobile communication network connection of the UE; determine whether there is another authentication being performed with the HN on a second mobile communication network connection for the UE or not; and when there is another authentication being performed with the HN on the second mobile communication network connection, delay the fetching of the authentication vector or reject the request.

According to a third aspect of the disclosure, there is provided a method performed by a user equipment (UE). The method comprises: receiving from a network node, a request to perform an authentication with a home network (HN) of the UE on a first mobile communication network connection of the UE; determining whether there is another authentication being performed with the HN on a second mobile communication network connection for the UE or not; and when there is another authentication being performed with the HPLMN on the second mobile communication network connection, delaying the authentication on the first mobile communication network connection or reject the request.

According to fourth aspect of the disclosure, there is provided a method performed by a at a unified data management (UDM) node in a home network (HN) of a user equipment (UE). The method comprises: receiving from an authentication server function (AUSF) node, a request to fetch an authentication vector for an authentication between the HN and the UE on a first mobile communication network connection of the UE; determining whether there is another authentication being performed with the HN on a second mobile communication network connection for the UE or not; and when there is another authentication being performed with the HPLMN on the second mobile communication network connection, delaying the fetching of the authentication vector or rejecting the request.

According to fifth aspect of the present disclosure, it is provided a computer readable storage medium, on which instructions are stored, when executed by at least one processor, the instructions cause the at least one processor to perform any method according to the third aspect.

According to sixth aspect of the present disclosure, it is provided computer program product comprising instructions which when executed by at least one processor, cause the at least one processor to perform any method according to the fourth aspect.

According to seventh aspect of the present disclosure, it is provided an apparatus implemented at an authentication and key management for application anchor function (AAnF) node. The apparatus comprises at least one processor; and at least one memory storing instructions that, when executed by the at least one processor, cause the apparatus at least to: receive from an authentication server function (AUSF) node, a first authentication and key management for application (AKMA) key material for an application of a user equipment (UE), together with a first identifier of a first serving public land mobile network (PLMN) or a first serving standalone non-public network (SNPN) which provides a first mobile communication network connection for the application; store the first AKMA key material per PLMN or SNPN based on the first identifier; receive from the AUSF node, a second AKMA key material for the application together with a second identifier of a second serving PLMN or a second serving SNPN which provides a second mobile communication network connection for the application; store the second AKMA key material per PLMN or SNPN based on the second identifier, with maintaining the stored the first AKMA key material; receive from an application function (AF) node, a request for an application key for the application of the UE, wherein the request indicates an identifier of PLMN or SNPN; select an AKMA key material from the first AKMA key material and the second AKMA key material according to the identifier of PLMN or SNPN indicated by the request; and provide to the AF node, an application key corresponding to the selected AKMA key material.

According to eighth aspect of the present disclosure, it is provided an apparatus implemented at an application function (AF) node. The apparatus comprises at least one processor; and at least one memory storing instructions that, when executed by the at least one processor, cause the apparatus at least to: receive from a user equipment (UE), a session request to request a session of an application; determine an identifier of a serving public land mobile network (PLMN) or a serving standalone non-public network (SNPN), which provides a mobile communication network connection for the session; and send to an authentication and key management for application anchor function (AAnF) node, a request for an application key for the session. The request indicates the identifier of the serving PLMN or the serving SNPN.

According to ninth aspect of the present disclosure, it is provided another apparatus implemented at a user equipment (UE), The apparatus comprises at least one processor; and at least one memory storing instructions that, when executed by the at least one processor, cause the apparatus at least to: send a session request to request a session from an application function (AF) node. The request comprises an identifier of a serving public land mobile network (PLMN) or a serving standalone non-public network (SNPN), which provides a mobile communication network connection for the session.

According to tenth aspect of the present disclosure, it is provided a method performed by an authentication and key management for application anchor function (AAnF) node. The method comprises: receiving from an authentication server function (AUSF) node, a first authentication and key management for application (AKMA) key material for an application of a user equipment (UE), together with a first identifier of a first serving public land mobile network (PLMN) or a first serving standalone non-public network (SNPN) which provides a first mobile communication network connection for the application; storing the first AKMA key material per PLMN or SNPN based on the first identifier; receiving from the AUSF node, a second AKMA key material for the application together with a second identifier of a second serving PLMN or a second serving SNPN which provides a second mobile communication network connection for the application; storing the second AKMA key material per PLMN or SNPN based on the second identifier, with maintaining the stored the first AKMA key material; receiving from an application function (AF) node, a request for an application key for the application of the UE, wherein the request indicates an identifier of PLMN or SNPN; selecting an AKMA key material from the first AKMA key material and the second AKMA key material according to the identifier of PLMN or SNPN indicated by the request; and providing to the AF node, an application key corresponding to the selected AKMA key material.

According to eleventh aspect of the present disclosure, it is provided a method performed by an application function (AF) node. The method comprises: receiving from a user equipment (UE), a session request to request a session of an application; determining an identifier of a serving public land mobile network (PLMN) or a serving standalone non-public network (SNPN), which provides a mobile communication network connection for the session; and sending to an authentication and key management for application anchor function (AAnF) node, a request for an application key for the session. The request indicates the identifier of the serving PLMN or the serving SNPN.

According to twelfth aspect of the present disclosure, it is provided another method performed by a user equipment (UE). The method comprises: sending a session request to request a session from an application function (AF) node. The request comprises an identifier of a serving public land mobile network (PLMN) or a serving standalone non-public network (SNPN), which provides a mobile communication network connection for the session.

According to thirteenth aspect of the present disclosure, it is provided a computer readable storage medium, on which instructions are stored, when executed by at least one processor, the instructions cause the at least one processor to perform any method according to the tenth aspect.

According to fourteenth aspect of the present disclosure, it is provided computer program product comprising instructions which when executed by at least one processor, cause the at least one processor to perform any method according to the eleventh aspect.

According to fifteenth aspect of the present disclosure, it is provided computer program product comprising instructions which when executed by at least one processor, cause the at least one processor to perform any method according to the twelfth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings in which:

FIG. 1 illustrates an exemplary scenario of a mismatching between security contexts;

FIG. 2 illustrates an exemplary procedure according to a first embodiment of the present disclosure;

FIG. 3 illustrates another exemplary procedure according to a second embodiment of the present disclosure;

FIG. 4 illustrates another exemplary procedure according to a third embodiment of the present disclosure;

FIG. 5 is a flow chart depicting a method according to embodiments of the present disclosure;

FIG. 6 is a flow chart depicting a method according to embodiments of the present disclosure;

FIG. 7 is a flow chart depicting a method according to embodiments of the present disclosure;

FIG. 8 is a flow chart depicting a method according to embodiments of the present disclosure;

FIG. 9 is a flow chart depicting a method according to embodiments of the present disclosure; and

FIG. 10 shows a simplified block diagram of an apparatus according to an embodiment of the present disclosure.

### DETAILED DESCRIPTION

Some example embodiments will now be described in more detail hereinafter with reference to the accompanying drawings, in which some, but not all embodiments are shown. Indeed, the example embodiments may take many different forms and should not be construed as fixed to the embodiments set forth herein; rather, these embodiments are provided so that this disclosure will satisfy applicable legal requirements. Like reference numerals refer to like elements throughout.

References in the present disclosure to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

In the following description and claims, unless defined otherwise, all technical and scientific terms used herein have the same meaning as commonly understood by one of ordinary skills in the art to which this disclosure belongs.

As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

As used in this application, the term “circuitry” may refer to one or more or all of the following:
(a) hardware-only circuit implementations (such as implementations in only analog and/or digital circuitry) and
   (b) combinations of hardware circuits and software, such as (as applicable):
      (i) a combination of analog and/or digital hardware circuit(s) with software/firmware and
      (ii) any portions of hardware processor(s) with software (including digital signal processor(s)), software, and memory(ies) that work together to cause an apparatus, such as a mobile phone or server, to perform various functions) and
   (c) hardware circuit(s) and or processor(s), such as a microprocessor(s) or a portion of a microprocessor(s), that requires software (e.g., firmware) for operation, but the software may not be present when it is not needed for operation.

This definition of “circuitry” applies to all uses of this term in this application, including in any claims. As a further example, as used in this application, the term “circuitry” also covers an implementation of merely a hardware circuit or processor (or multiple processors) or portion of a hardware circuit or processor and its (or their) accompanying software and/or firmware. The term “circuitry” also covers, for example and if applicable to the particular claim element, a baseband integrated circuit or processor integrated circuit for a mobile device or a similar integrated circuit in server, a cellular network device, or other computing or network device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read, The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

In the following, certain embodiments are explained with reference to cellular communication terminals (or user equipment (UE)) capable of cellular communication on a radio access, via cells, base stations, WiFi access point or similar wireless transmitter and/or receiver nodes, providing access points for a radio access system. The radio access system can be arranged to allow mobile communication network connections established between a UE and a home network or a network entity of the home network of the UE. The radio access system may be a 3GPP access system, or a non-3GPP access system. The home network may be a public land mobile network (PLMN) or a standalone non-public network (SNPN).

The cellular communication terminal or UE may comprise any suitable device capable of at least receiving cellular communication of data. For example, the cellular communication terminal or UE can be handheld data processing device equipped with radio receiver, data processing and user interface apparatus. Non-limiting examples include a mobile station (MS) such as a mobile phone or what is known as a “smart phone”, a portable computer such as a laptop or a tablet computer provided with a wireless interface card or other wireless interface facility, personal data assistant (PDA) provided with wireless communication capabilities, or any combinations of these or the like. Further examples include wearable wireless devices such as those integrated with watches or smart watches, eyewear, helmets, hats, clothing, ear pieces with cellular connectivity, jewelry and so on, universal serial bus (USB) sticks with cellular capabilities, modem data cards, machine type devices or any combinations of these or the like.

According to protocols for cellular communication, before initiating communication with a cellular communication network, such as a fifth generation (5G) system, a cellular communication terminal or UE, needs to have performed primary authentication and registered with its home network, such as home PLMN or home SNPN. Keys to be utilized for application layer security would be derived based on keys generated in the primary authentication (e.g., a key K_{AUSF}, and other keys derived from K_{AUSF}, such as key K_{AKMA}). Security contexts would be created by the primary authentication.

Traditionally, there are two cases where the UE can be multiple registered in different PLMN's serving networks or in the same PLMN's serving networks. The first case is when the UE is registered in one PLMN serving network over a certain type of access (e.g. 3GPP) and is registered to another PLMN serving network over the other type of access (e.g. non-3GPP). The second case is where the UE is registered in the same AMF in the same PLMN serving network over both 3GPP and non-3GPP accesses.

The UE will establish two NAS connections with its home network in both cases. The UE shall independently maintain and use two different 5G security contexts, one per PLMN's serving network. Each NAS security context shall be established separately via a successful primary authentication procedure with a HPLMN. A mobile equipment (ME) of the UE could store the two different 5G security contexts on a universal subscriber identity module (USIM) of the UE if the universal subscriber identity module (USIM) or universal integrated circuit card (UICC) of the UE supports the 5G parameters storage. If the USIM/UICC does not support the 5G parameters storage, then the ME could store the two different 5G security contexts in the ME non-volatile memory. Both of the two different 5G security contexts are current 5G security context.

The latest K_{AUSF} result of the successful completion of a latest primary authentication shall be used by the UE and the HPLMN regardless over which access network type (3GPP or non-3GPP) it was generated. The HPLMN would keep the latest K_{AUSF} generated during successful primary authentication over a given access, even if the UE is deregistered from that access, but the UE is registered via another access.

In 3GPP release 19, additional cases for multiple registrations may be possible due to 5G system support of upper layer steering, split and switching of UE's traffic (e.g. pertaining to a same data session) across two 3GPP access links, assuming only single subscription to a PLMN, including the following scenarios:
Single PLMN, PLMN plus standalone non-public network (SNPN), two PLMNs
Same or different 3GPP radio access technologies (RATs) (e.g., new radio (NR) or non-terrestrial network (NTN), plus one of NR, NTN or long term evolution (LTE))

Please note that the NTN here can refer to NR-based satellite access, including different orbits (e.g., geostationary orbit (GEO), medium-earth orbit (MEO), low-earth orbit (LEO)).

For the PLMN plus PLMN/SNPN scenarios, two serving PLMN networks can be managed by a same operator or by different operators (assumed to have a business agreement among them. Three different scenarios of registrations that can be considered for above cases are listed below.
UE registered twice in a same serving PLMN;
UE registered with two serving PLMNs (denoted as PLMN #1 & PLMN##2, respectively) or two stand-alone NPN (SNPN) (SNPN #1 & SNPN #2);
UE registered with two PLMNs (denoted as PLMN #1 & denoted as PLMN #2) or registered with a PLMN and a SNPN.

For all of these cases, at a HPLMN of the UE, only one K_{AUSP} is stored (from latest primary authentication on a radio access-either 3GPP or non-3GPP), which will be used for UE parameters update (UPU), authentication and key management for application (AKMA), and steering of roaming (SoR), and the like.

Concurrent runs of security procedures may, in certain situations, lead to mismatches between security contexts in the network and the UE. Thus, traditionally, it is specified in protocol that a UE shouldn't trigger registration for a 3GPP access and a non-3GPP access at same time. Then, only sequentially trigger registration it is allowed. In this regard, if the UE is performing registration over a first access and intends to perform registration over the other access in a same PLMN (e.g. the 3GPP access and the selected Non-3GPP interworking function (N3IWF), trusted non-3gpp gateway function (TNGF) or wireline access gateway function (W-AGF) are located in the same PLMN), the UE shall not initiate the registration over the other access until the registration procedure over a first access is completed.

For example, concurrent runs of security procedures in parallel over two different NAS connections when terminated in the same AMF can lead to race conditions and mismatches between the security contexts in the HPLMN and the UE. In order to avoid such mismatches, the following rules shall be followed, as specified in 3GPP TS 33.501 V17.6.0:
1. The security anchor function (SEAF) or access and mobility management function (AMF) shall not initiate a primary authentication or NAS security mode command (SMC) procedure in case another primary authentication or a NAS SMC procedure is ongoing on a parallel NAS connection. Authentication procedures followed by a NAS SMC procedure taking the new 5G security context into use, shall be performed on one NAS signaling connection at a time.
2. When the AMF has sent a NAS Security Mode Command to a UE in order to take a new K_{AMF} into use and receives a security context transfer request message for the UE from another AMF, the AMF shall wait for the completion of the NAS SMC procedure (e.g. receiving NAS Security Mode Complete) before transferring the security context.
3. The UE shall not initiate a NAS registration over a second NAS connection to an AMF of the same network before primary authentication on the first NAS connection is complete.

However, it is still possible for concurrent runs of security procedures in parallel to occur, For example, due various conditions, two primary authentication and key agreement (AKA) procedures can run in parallel for a single UE over different PLMNs, e.g., when a UE performs the following procedures:
a mobility registration update (MRU) procedure over 3GPP access in PLMN A and primary AKA is involved in the MRU; and
an initial registration procedure over non-3GPP access in PLMN B and primary AKA is involved in the initial registration.

In such a case, there can be a mismatch in K_{AUSF} between the UE and its home network (HN). For example, when the UE receives a security mode command message over the 3GPP access from PLMN A later than a security mode command message over the non-3GPP access from PLMN B even if an AUSF in the HN indicated that the authentication was successful to a SEAF of PLMN A earlier than a SEAF of PLMN B. From the UE or HN perspective, K_{AUSF} agreed via PLMN B or PLMN A, respectively, is the latest one.

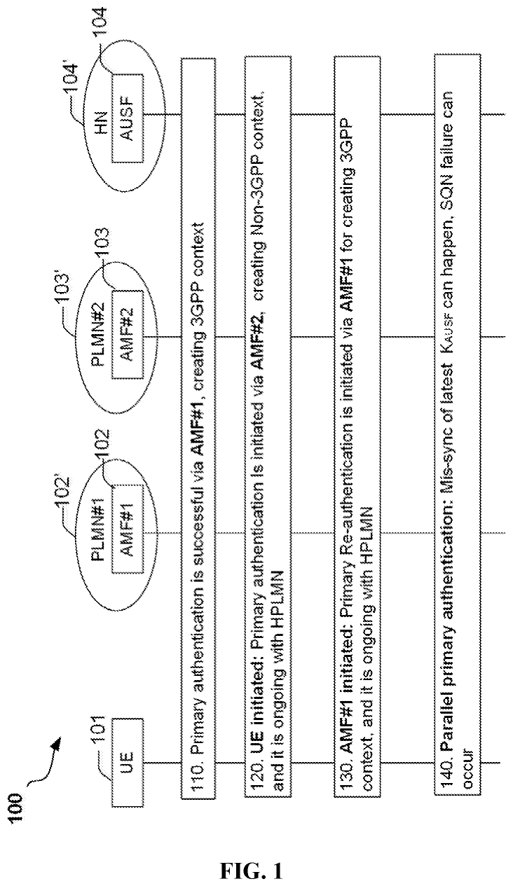

FIG. 1 illustrates an exemplary scenario, in which two security procedures run in parallel, causing a mismatching between security contexts.

At step 110, a primary authentication (denoted as a first primary authentication) is successfully performed between UE 101 and its HPLMN 104′ (e.g., with AUSF 104), via a first AMF 102 (denoted as AMF #1). At that time, a first visited PLMN 102′ (denoted as VPLMN #1) is a serving PLMN which is providing a first radio access to the UE 101. For example, when UE 101 tries to register to VPLMN #1, e.g., by sending a registration request to the AMF 102, the first primary authentication would be triggered. From the first primary authentication, a key K_{AUSF} (denoted as K_{AUSF(1)} would be generated, and security context may be created. In an embodiment, the first radio access may be a 3GPP access. Then, 3GPP security context (i.e., NAS context) may be created from the first primary authentication. Upon a successful complete of the first primary authentication, the 3GPP security context would be available in the UE 101 and AMF #1 102, and the K_{AUSF(1)} would available at the UE 101 and the AUSF 104.

At step 120, the UE 101 may initiate another primary authentication (denoted as a second primary authentication with the HPLMN 104′, via a second AMF 103 (denoted as AMF #2). For example, the UE 101 may try to register to a second visited PLMN 103′ (denoted as VPLMN #2), e.g., by sending an initial registration request to AMF #2. Then, the second primary authentication may be triggered for creating security context for the AMF #2. The UE 101 may be able to perform cellular communication over two different radio accesses at the same time. At step 120, the second visited PLMN 102′ is providing a second radio access to the UE 101, while the first radio access is still maintained. A key K_{AUSF} (denoted as K_{AUSF(2)} different from K_{AUSF(2)} would be generated from the second primary authentication. In an embodiment, the second radio access may be a non-3GPP access, such as a radio access in accordance with Wi-Fi, wireless local access network (WLAN) techniques, and the like.

Because the security context would not be delivered among different PLMN, PLMN #1 does not know the second primary authentication is ongoing over VPLMN #2. When the second primary authentication is ongoing, a further primary authentication (denoted as a third primary authentication) may be triggered over VPLMN #1 towards the UE 101, as shown at step 130. For example, AMF #1 may decide to re-authenticate the UE 101. The re-authentication may be triggered by a UDM in the HPLMN 104′ (e.g. triggered by a service request procedure). The original latest key K_{AUSFA(1)} generated for the first radio access would be kept in use in the HPLMN 104′.

Then, as shown at step 140, parallel primary authentication would occur, causing mismatch or mis-synchronization of latest K_{AUSF}. In other words, it would be a problem to determine which K_{AUSF} (K_{AUSF(2)} generated from the second primary authentication or K_{AUSH(1)} generated from the first primary authentication) is considered as the latest K_{AUSF} in the UE 101 and the HPLMN 104′ (e.g., AUSF 104). For example, if the UE 101 sent an authentication response message over the 3GPP access (the first radio access) to VPLMN #1 for the third primary authentication later than an authentication response message over the non-3GPP access (the second access) to VPLMN #2 for the second primary authentication, but AMF #1 invokes an Nausf service earlier to the HPLMN 104′ than AMF #2, then the UE 101 may consider K_{AUSP(1)} (from the 3GPP access) as a latest one, while the HPLMN 104′ may consider K_{AUSF(2)} (from the non-3GPP access) as a latest one. The parallel primary authentication may further result in sequence number (SQN) mis-synchronization issue in 5G case (which may be resolved by the UE 101 with a parameter AUTS) , or may cause extensible authentication protocol (EAP) authentication failure in RAP-AKA′ case (if AUSF 104 couldn't proceed the two authentication request correctly) as EAP is a “lock step” protocol.

Due to this mismatch (or mis-synchronization) of latest K_{AUSF} between the HPLMN and the UE, the UE 101 will not be able to access services. This would result in mis-synchronization in authentication and key management for application (AKMA) use case, as further keys for AKMA is dependent on the key K_{AUSF} used in the AUSF 104 and the UE 101. The mismatch in K_{AUSF} between the HPLMN and the UE results in errors in SOR, UPU, and AKMA

Current specifications of the 3rd Generation Partnership Project (3GPP) do restrict this problem occurred when one authentication is UE-triggered and another authentication is home network-triggered.

Please note that the above issue is described with two different types of radio accesses, but this issue is also valid for two radio accesses of a same 3GPP type. For example, in access traffic steering, switching, splitting (ATSSS) use case of 3GPP release 19, a UE can connect to two radio access network (RAN) node simultaneously for one same 3GPP access, In this scenario, this issue will be more prominent.

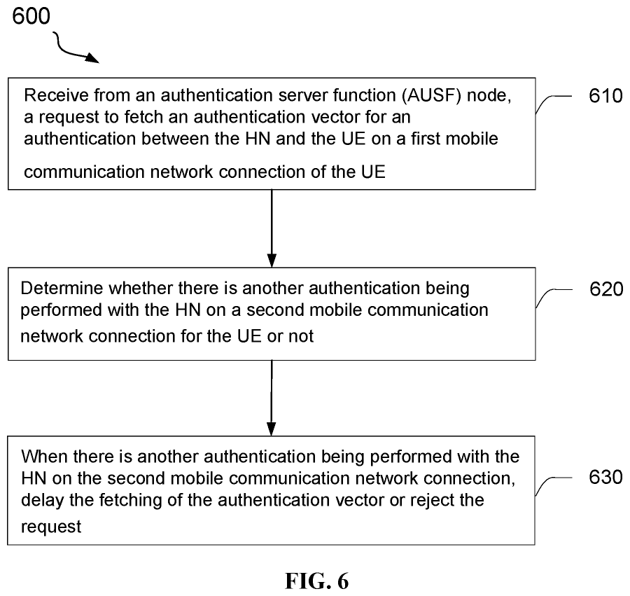

The present disclosure proposes several solutions for this issue. According to a first embodiment, a UDM-based solution is provided, in which if there is another ongoing authentication for a UE, a UDM in the HN delays a current requested authentication of the UE. In this solution, a unified data repository (UDR) is involved in primary authentication. In contrast, in the current specifications, a UDR is not involved in primary authentication (e.g., as shown in step 2 of 3GPP TS 33.501 V17.6.0 figure 6.1.3.1-1). It is just UDM and authentication credential repository and processing function (ARPF) are involved in primary authentication.

In this solution, the UDR can maintain temporary status information (e.g., indicating an authentication interim status) for primary authentication, when the primary authentication is performed or completed. For example, a UDM may store the temporary status information into the UDR, when a UDM receives a request for authentication vector from an AUSF for the primary authentication. The temporary status information indicates a status of a primary authentication for the UE, i.e., the authentication is ongoing. In another example, the UDM may send and stored the temporary status information to the UDR after the UDM send the requested authentication vector (AV) (e.g., comprising RAND, AUTN, XRES, CK', IK') to the AUSF, from which it received an authentication get request. For example, the UDM may send and stored the temporary status information to the UDR, when an AKA challenge of primary authentication is triggered.

In an embodiment, one UDM can comprise several UDM instances. For example, the routing indicator in a subscription concealed identifier (SUCI) of a UE can be used to identify the right UDM instance that is capable of serving the UE. In this case, a UDM instance (denoted as UDM1) identified for the UE can send the temporary status information to the UDR.

Therefore, when an authentication get request for a primary authentication on a mobile communication network connection of the UE is received at a UDM in the UE's home network, e.g., at a UDM instance (e.g., at the same UDM1 or another UDM instance denoted as UDM2), the UDM (or UDM2) can first check status of authentication for the UE in the UDR. The mobile communication network connection is connected to the UE via a first radio access which may be non-3GPP access or 3GPP access. If it is found that another authentication on another mobile communication network connection of the UE is ongoing, then the UDM2 may delay the currently requested authentication, e.g., till said another authentication is completed. Said another mobile communication network connection may be connected to the UE over a radio access, which may be different from or same as the first radio access. In an example, the UDM2 may delay a provision of authentication vector (AV) to AUSF e.g., by some seconds. In another example, the UDM2 may inform AMF about the ongoing authentication, e.g., with a new error code, so that the AMF can also delay the currently requested authentication. Alternatively, if it is found that another authentication for the UE is ongoing, then the UDM2 may reject the currently requested authentication. In this way, the currently requested authentication would not be performed in parallel with the ongoing authentication, avoiding mismatch in keys (such as K_{AUSF}) between the UE and its home network.

According to a second embodiment, a UE-based solution is provided, in which if there is another ongoing authentication, the UE delays a current requested authentication. In this solution, when a UE is requested to perform a primary authentication on a first mobile communication network connection, the UE would determine whether another authentication on a second mobile communication network connection for the UE is ongoing. For example, a 5G mobility management (5GMM) sublayer for the first radio access in the UE would check the other 5GMM sublayer for a second mobile communication network connection before proceeding the requested primary authentication. If a primary authentication on the second mobile communication network connection is ongoing, the 5GMM sublayer for the first mobile communication network connection can delay the requested primary authentication to wait for the authentication on the second mobile communication network connection to be completed.

In an example, if a UE needs to send an authentication response message (e.g., in response to an authentication request for a primary authentication on the first mobile communication network connection of the UE) over a current access to a PLMN and a primary authentication and key agreement procedure (e.g., on the second mobile communication network connection of the UE) is ongoing via the other access over a different PLMN, the UE can send the authentication response message after the primary authentication and key agreement procedure over the different PLMN is completed.

Alternatively, the UE can reject the requested authentication. The UE may generate an error code in response to an authentication request if another authentication is on-going. For example, the UE can send an authentication failure message indicating a cause of the failure (e.g., authentication ongoing on the second mobile communication network connection). In this way, mismatch in keys (such as K_{AUSF}) between the UE and its home network can be avoided.

In a scenario where a UE is getting attached to two RAN nodes and the two RAN nodes are connected to two AMFs, the above UDM-based solution may be applied in a same way as the a scenario where the first radio access and the second radio access are of different types (i.e., one is 3GPP access, the other is non-3GPP access), If two RAN nodes are connected to the same AMF, then this AMF can ensure that the requested authentication is delayed until the ongoing authentication is completed.

According to a third embodiment, a solution mandating AKMA per PLMN or SNPN is provided. Please note that mandating AKMA per PLMN or SNPN is only for the protection, because it is not aligned with current standards where only one K_{AUSF} (the latest K_{AUSF}) is stored. In this solution, a UE and its home network derive AKMA key material (such as the K_{AKMA} and the AKMA Temporary Identifier (A-TID) for an application from a valid K_{AUSF} of a serving PLMN or a serving SNPN through which traffic of the application is delivered. The AKMA key material may be stored in an authentication and key management for application anchor function (AAnF) node per PLMN. For example, if an application (denoted as Application X) running on a UE requests K_{AKMA} and A-TID and the traffic of Application X is delivered via a serving PLMN (denoted as PLMN A), the UE derives the K_{AKMA} and the A-TID from the valid K_{AUSF} of PLMN A and then provides the K_{AKMA} and the A-TID to Application X. Application X can be also an application in an application layer. Application X can be “upper layers” above a system layer. The home network (e.g., AUSF) may store the K_{AKMA} and the A-TID for Application A into AAnF based on an identifier of the PLMN A. In a similar way, another K_{AKMA} and A-TID for the application derived from another K_{AUSF} of another serving PLMN (PLMN B) may also be stored into the AAnF, with the K_{AKMA} and the A-TID for Application A still being stored or maintained in the AAnF.

When an AF requests an application key (i.e., K_{AF}) for an application to AAnF, the AF can indicate the identifier (e.g., ID) of a serving PLMN or a serving SNPN providing radio access for the application as well. For example, in an application session establishment request message, the UE can indicate ID of its serving PLMN or serving SNPN to the AF. The ID may be sent the AAnF together with the key request for K_{AF}. Alternatively, the AF may know the UE's serving PLMN or serving SNPN via other means. In an example, the AF may determine which PLMN or SNPN should be selected for the UE based on a policy of the home network. In response, the AAnF may select K_{AKMA} which was generated from K_{AUSF} of the serving PLMN or serving SNPN, and then provides K_{AF} derived from the selected K_{AKMA} to the A_{F}. In this way, although the latest K_{AUSF}hold in its home network (e.g., in AUSF) may be different from a latest K_{AUSF} hold in UE, the AF may obtain same application keys (e.g., K_{AF}) as that derived in the UE. Thus, the UE will be able to access services by using these application keys.

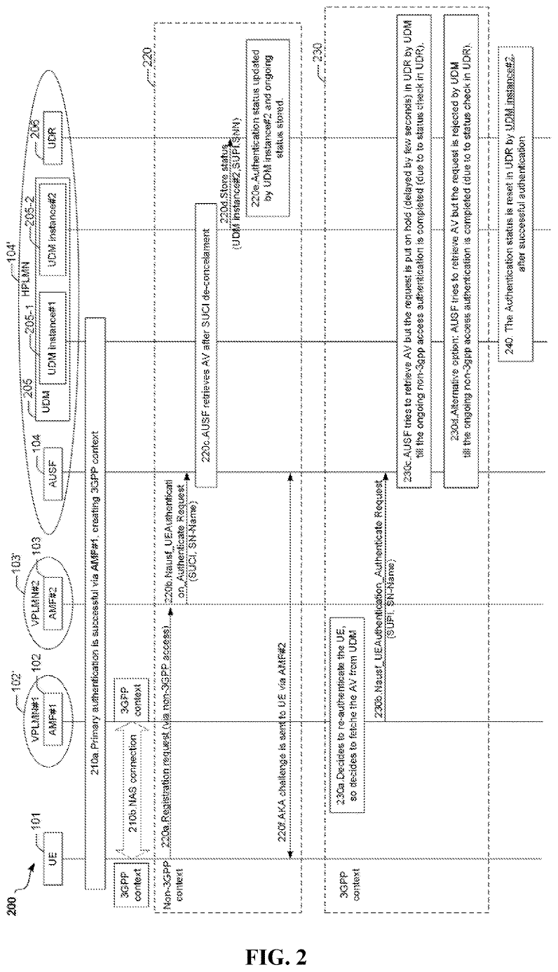

Referring now to FIG. 2, an exemplary procedure 200 according to the first embodiment is illustrated. At step 210a, a primary authentication is successfully performed between UE 101 and its HPLMN 104′, via a first AMF 102 (denoted as AMF #1). At that time, a first visited PLMN 102′ (denoted as VPLMN #1) is a serving PLMN which is providing a first radio access to the UE 101. For example, when UE 101 tries to register to VPLMN #1, e.g., by sending a registration request to the AMF 102, the first primary authentication would be triggered.

As shown at step 210b, after a successful complete of the first primary authentication, a NAS connection is established between UE 101 and AMF #1 102. 3GPP security context (i.e., NAS context) created from the first primary authentication may be available in the UE 101 and AMF #1 102. In the UE side, 3GPP security context is either stored in ME or USIM/UICC (e.g., as EF file EF5GS3GPPNSC). The content of this context may comprise the key K_{AMF} with the associated key set identifier, the UE security capabilities, the uplink and downlink NAS COUNT values, as specified in Annex C in 3GPP TS 24.501V18.0.1 .

Then, in a process 220, the UE 101 may initiate another primary authentication (denoted as a second primary authentication with the HPLMN 104′, via a second AMF 103 (denoted as AMF #2) which belongs to a second visited PLMN 103′ (denoted as VPLMN #2). As shown at step 220a, the UE 101 initiates a registration request on a non-3GPP radio access using SUCI of the UE 101, towards the second AMF #2 103 (denoted as AMF #2). At step 220b, the AMF #2 forwards an authentication request towards AUSF 104. The request may comprise the SUCI of the UE 101 and a SN-Name identifying the PLMN 103′. Then the AUSF 104 retrieves an authentication vector from a UDM 205 after SUCI de-concealment. Through the SUCI de-concealment, a SUPI of the UE 101 may be obtained.

According to an embodiment of this disclosure, after providing the authentication vector to the AUSF 104, the UDM 205 may store temporary status information to a UDR 206, indicating that a status of a primary authentication for the UE, i.e., the second authentication is ongoing. As shown at step 220d, a UDM instance 205-2 (denoted as UDM instance #2) which is assigned for the second authentication may send the temporary status information, e.g., indicative of “ongoing authentication” in the UDR 206, together with UDM instance #2, serving network name (SNN) and SUPI of the UE 101. At step 220e, authentication status of the UE 101 updated by the UDM instance #2 and the temporary status information indicative of “ongoing authentication” may be stored in the UDR 206. After the update of authentication in the UDR 206, an AKA challenge may be sent to the UE 101 via AMF #2, as shown at step 220f.

In parallel, in a process 230, a further primary authentication (denoted as a third primary authentication) may be triggered over VPLMN #1 towards the UE 101, before the second authentication of the process 220 is completed. As the AMF #1 (to which the UE 101 connected via a 3GPP radio access), which belongs to VPLMN #1, is not aware of the ongoing second authentication in another access (non-3GPP), a re-authentication may be triggered by the AMF #1 for a same SUPI (i.e., the UE 101). As shown at step 230a, the AMF #1 decides to re-authenticate the UE, and so decides to fetch an authentication vector (AV) from the UDM 205. The AMF #1 can send an authentication request message to the HPLMN 104′ to fetch the AV, as shown at step 230b.

Then, at step 230c, in response to the authentication request message, the AUSF 104 tries to retrieve the AV from the UDM 205. For example, the AUSF 104 may send an authentication get request to a UDM instance 205-1 (denoted as UDM instance #1) assigned for the third authentication. Then, the UDM instance #1 may check the status of ongoing authentication of the UE 101 from the UDR 206. It would be found that there is another authentication (i.e., the second primary authentication) over the non-3GPP radio access for the UE 101 is ongoing. Then, the UDM instance #1 can delay the current authentication request from the AMF #1 as shown at step 330c. In an alternative embodiment, the UDM instance #1 can reject the current authentication request from AMF #1, as shown at step 340c. So AMF #1 can re-trigger a re-authentication later.

Once the non-3GPP access authentication (the second primary authentication) is completed, the temporary status information for the second primary authentication in the UDR 206 may be reset, e.g., by the UDM instance #2, as shown at step 240. Then, other 3GPP access authentication will be allowed when requested or resumed if it is on hold. In an example, the UDM instance #1 may periodically check the temporary status information for the second primary authentication, and notify the AMF #1 to re-trigger a re-authentication, once it found that the temporary status information is reset. In another example, the UDM instance #2 may notify the UDM instance #1 that the second primary authentication is completed, so that the UDM instance #1 can notify the AMF #1 to re-trigger a re-authentication.

It can be understood that although the above call flow 200 is for parallel authentication over different radio accesses, it is also applicable to the case where multiple RAN nodes (with multiple registrations) are involved in the 3GPP access, such as ATSSS use cases in 3GPP release 19. In embodiments for those use cases, both the first radio access and the second radio access are 3GPP access.

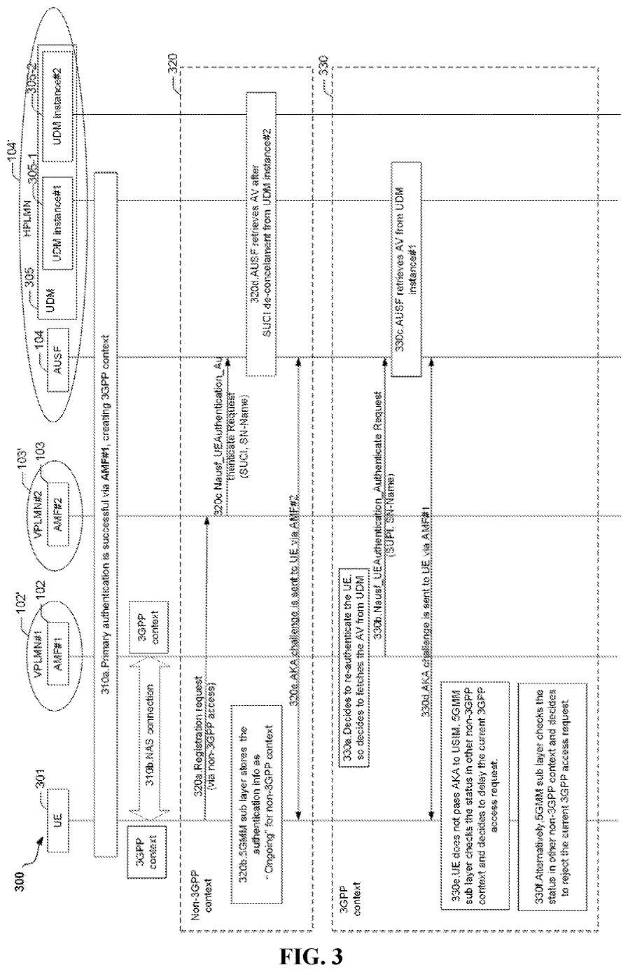

Referring now to FIG. 3, an exemplary procedure 300 according to the second embodiment is illustrated. At step 310a, a primary authentication (also denoted as a first primary authentication) is successfully performed between UE 301 and its HPLMN 104′, via a first AMF 102 (denoted as AMF #1). At that time, a first visited PLMN 102′ (denoted as VPLMN #1) is a serving PLMN which is providing a first radio access to the UE 301. For example, when UE 301 tries to register to VPLMN #1, e.g., by sending a registration request to the AMF #1 102, the first primary authentication would be triggered.

As shown at step 310b, after a successful complete of the first primary authentication, a NAS connection is established between UE 401 and AMF #1 102. 3GPP security context (i.e., NAS context) created from the first primary authentication may be available in the UE 401 and AMF #1 102. In the UE side, 3GPP security context is either stored in ME or USIM/UICC (e.g., as EF file EF5GS3GPPNSC). The content of this context may comprise the key K_{AMF} with the associated key set identifier, the UE security capabilities, the uplink and downlink NAS COUNT values, as specified in Annex C in 3GPP TS 24.501V 18.0.1 .

Then, in a process 320, the UE 301 may initiate another primary authentication (denoted as a second primary authentication with the HPLMN 104′, via a second AMF 103 (denoted as AMF #2) which belongs to a second visited PLMN 103′ (denoted as VPLMN #2). As shown at step 320a, the UE 301 initiates a registration request on a non-3GPP radio access using SUCI of the UE 301, towards the second AMF #2 103. At step 320c, the AMF #2 forwards an authentication request towards AUSF 104. The request may comprise the SUCI of the UE 101 and a serving network (SN)-Name identifying the PLMN 103′. Then, at step 320d, after SUCI de-concealment, a SUPI of the UE 201 may be obtained and the AUSF 104 may retrieve an authentication vector for the UE 301 from a UDM 305, e.g., from a UDM instance 305-2 (denoted as UDM instance #2) which is assigned for the second authentication. The AUSF 104 may sends an AKA challenge to the UE.

According to embodiments of this disclosure, a 5GMM sublayer in the UE 301 would store an indication of authentication status as “ongoing” for the second authentication, for example, when the second authentication is triggered, as shown at step 320b.

In parallel, in a process 330, a further primary authentication (denoted as a third primary authentication) may be triggered over VPLMN #1 towards the UE 301, before the second authentication of the process 320 is completed. As the AMF #1 (to which the UE 301 connected via a 3GPP radio access), which belongs to VPLMN #1, is not aware of the ongoing second authentication in another access (non-3GPP), a re-authentication may be triggered by the AMF #1 for a same SUPI (i.e., the UE 301), As shown at step 330a, the AMF #1 decides to re-authenticate the UE, and so decides to fetch an authentication vector (AV) from the UDM 305. The AMF #1 can send an authentication request message to the HPLMN 104′ to fetch the AV, as shown at step 330b.

At step 330c, in response to the authentication request message, the AUSF 104 fetch the AV from the UDM 305, e.g., from a UDM instance 305-1 (denoted as UDM instance #1) assigned for the third authentication. Then, an AKA procedure would be triggered, in which an AKA challenge is sent to the UE 301 via AMF #1 as shown at step 330d.

According to embodiments of this disclosure, the UE 301 would not pass the AKA challenge to its USIM/UICC. In response to the AKA challenge, the UE 301 would determine whether another authentication on a second radio access for the UE is ongoing. In this regard, a 5GMM sublayer may checks status of authentication for other mobile communication network connections of the UE 301. In case that it is found that the status of the second authentication is “ongoing”, the UE 301 may decide to relay the current third authentication, as shown at step 330e. So it delays the current request till step 2 triggered non-3GPP access authentication is completed In other words, the 5GMM sub layer doesn't pass the AKA challenge to the USIM/UICC of the UE, as the authentication status for the second mobile communication network connection is “authentication ongoing”. Alternatively, in case that it is found that the status of the second authentication is “ongoing”, the UE 301 may decide to reject the AKA challenge, as shown at step 330f. Accordingly, the current third authentication would be rejected. So AMF could re-trigger an authentication later.

Although not shown, once the second authentication is completed, the authentication status for the second authentication in the UE 301 would be reset, so that other authentication (e.g., the third authentication) will be allowed when requested or resumed if it is on hold.

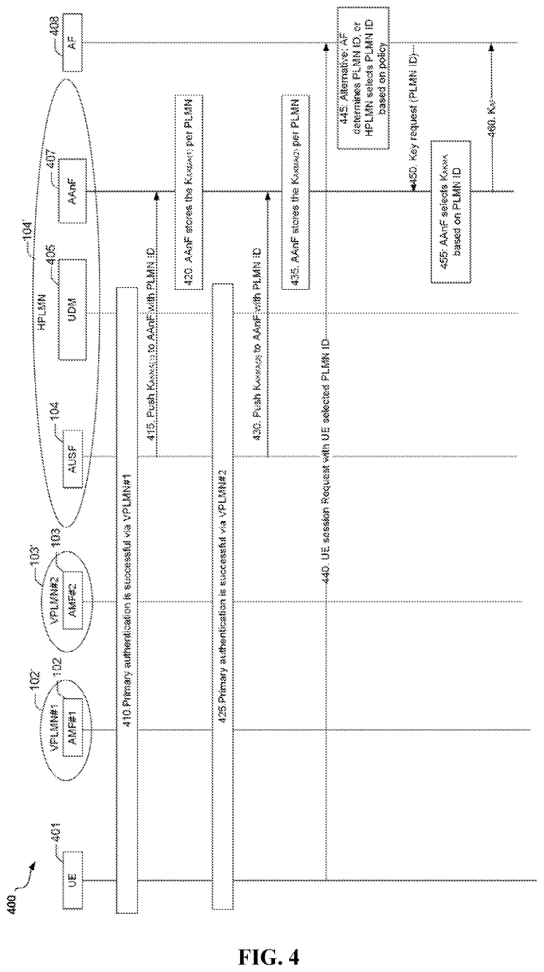

Referring now to FIG. 4, an exemplary procedure 400 for avoiding key mismatch in case of parallel authentication according to the third embodiment is illustrated. At step 410, a first primary authentication is successfully performed between UE 401 and its HPLMN 104′, via a first AMF 102 (denoted as AMF #1), At that time, a first visited PLMN 102′ (denoted as VPLMN #1) is a serving PLMN which is providing a first radio access to the UE 401. The UE 401 registers to VPLMN #1. Then, an AUSF 104 may generate keys K_{AUSF} and K_{AKMA} from the first primary authentication, and push the generated K_{AKMA} (denoted as K_{AKMA(1)} to an AAnF 407 as shown at step 415. The key K_{AKMA} is generated per PLMN, Accordingly, an identity (ID) of VPLMN #1 may be sent to the AAnF 407 together with the K_{AKMA(1)} in step 415. At step 420, the AAnF 407 would store and maintain this K_{AKMA(1)} per PLMN based on the ID of VPLMN #1.

At step 425, the UE 401 registers to second visited PLMN 103′ (denoted as VPLMN #2). Then, a second primary authentication is successfully performed between UE 401 and its HPLMN 104′, via a second AMF 103 (denoted as AMF #2), From the second primary authentication, an AUSF 104 may generate keys K_{AUSF} and K_{AKMA}, and push the generated K_{AKMA} (denoted as K_{AKMA(2)}) to an AAnF 407 together with an ID of VPLMN #2, as shown at step 430. Then, at step 435, the AAnF 407 would store and maintain this K_{AKMA(2)} per PLMN based on the ID of VPLMN #2. Different from the traditional approach, both the K_{AKMA(1)} and would K_{AKMA(2)} would be maintained in the AAnF 407.

When the UE 401 requests a session for an application from an AF 408 (as shown at step 440), a PLMN via which the application would be accessed could be determined. In an example, the UE 401 may provide a PLMN ID in the session request. Alternatively, the AF 408 may determine the UE's serving PLMN via other means, as shown at step 445. In another example, the HPLMN 104′ may select a VPLMN as a serving PLMN for the application according to a HPLMN policy, and then notify the ID of the selected PLMN to the AF 408.

Then, the AF 408 sends a request for an application key (i.e., K_{AF}) for the application to the AAnF 407. The ID of the serving PLMN for the application is comprised in the request, as shown at step 450.

In response, the AAnF 406 selects a corresponding K_{AKMA} based on the ID at step 455, and then provides an application key K_{AF} derived from the selected K_{AKMA} to the AF 408 at step 460.

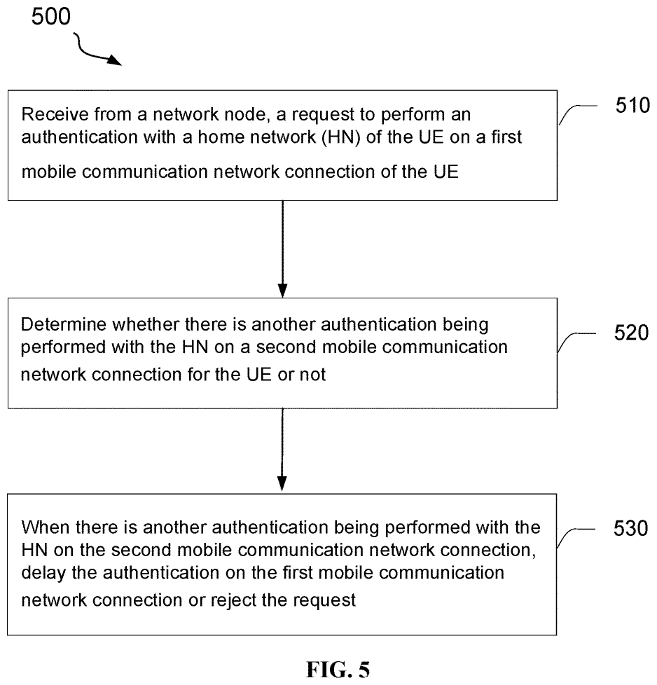

FIG. 5 is a flow chart depicting a method 500 according to embodiments of the present disclosure. The method 500 can be implemented at a UE, which may be any suitable mobile communication device. For example, the method 500 may be implemented at UE 301 as shown in FIG. 3.

As shown at block 510, the method 500 comprises receiving by the UE (such as, UE 301) from a network node (such as, AMF #1 shown in FIG. 3), a request to perform an authentication with a home network (HN), such as a PLMN or a SNPN, of the UE on a first mobile communication network connection of the UE. The authentication may be a primary authentication, or other authentication between the UE and a core network.

The method 500 further comprises determine whether there is another authentication being performed with the HN on a second mobile communication network connection for the UE or not, as shown at block 520. The second mobile communication network connection may be a parallel connection, authentication of which is triggered earlier then the first mobile communication network connection. In an example, a mobility management sublayer of the UE may store an indication of authentication status of each mobile communication network connection of the UE. When the authentication of a mobile communication network connection is triggered, an authentication status of the mobile communication network connection may be set to indicate that its authentication is ongoing. When an authentication of a mobile communication network connection is completed, its authentication status may be reset to indicate that its authentication is completed.

The method 500 further comprises when there is another authentication being performed with the HN on the second mobile communication network connection, delaying the authentication on the first mobile communication network connection or rejecting the request, as shown at block 530. In some embodiments, the authentication on the first mobile communication network connection may be delayed, until said another authentication is completed.

In some embodiments, the method 500 may further comprises: when said another authentication is being performed, rejecting the authentication on the first mobile communication network connection, and returning an error code to the network node.

In some embodiments, the method 500 may further comprise: when said another authentication is being performed, holding the authentication on the first mobile communication network connection until said another authentication is finished, without notifying the network node. It's similar to synchronized or blocking application program interface (API) or function pattern.

In some embodiments, the method 500 may further comprise: holding the authentication on the first mobile communication network connection, and sending a response to the network node immediately to inform the network node and the home network that said another authentication has not been finished. Meanwhile, the method 500 may further comprises: setting an expected timer in the response. Alternatively, the timer can be set on network side. It's similar to asynchronized or unblocking API or function pattern.

In some embodiments, the method 500 may further comprises: holding the authentication until timeout, and then sending an authentication failure notification with an error code to the network node.

Although not shown in FIG. 5, the method 500 further comprises when there is no another authentication being performed with the HN on the second mobile communication network connection, performing the authentication on the first mobile communication network connection.

In an embodiment, upon deciding to delay the authentication, the UE may further set a timer for timing when to end the delaying of the authentication. The timer duration can be an expected end time of the second authentication (which may be determined by the UE), or can be a predefined value, e.g., as specified in a protocol. Then, the UE may try to resume the delayed authentication when the timer is expired. When the delayed authentication cannot be resumed while the timer is expired reject, e.g., it is determined said another authentication is still ongoing while the timer is expired, the UE may reject the request.

In an embodiment, upon deciding to delay the authentication, the UE may send to the network node, a notification informing the network node and the HN that the authentication on the first mobile communication network connection is to be delayed. For example, the UE may send a response to the request, and the notification may be contained in the response. Then, the network node and the HN would know that the authentication has not been finished. A timer for timing when to end the delaying of the authentication may be also set in the response. Alternatively, the timer can be set on network side.

In an embodiment, upon deciding to reject the authentication, the UE may send to the network node an error code indicating that the request is rejected because said another authentication is being performed.

FIG. 6 is a flow chart depicting a method 600 according to embodiments of the present disclosure. The method 600 can be implemented at a unified data management node or a network function entity, which may be any suitable communication device. For example, the method 600 may be implemented at the UDM 205. It can be appreciated that the method 600 may be implemented at other network nodes or devices.

As shown at block 610, the method 600 comprises receiving from an AUSF node, a request to fetch an authentication vector for an authentication between the HN (such as a PLMN or a SNPN) and the UE on a first mobile communication network connection of the UE, as shown at block 610; determining whether there is another authentication being performed with the HN on a second mobile communication network connection for the UE or not, as shown at block 620; and when there is another authentication being performed with the HN on the second mobile communication network connection, delay the fetching of the authentication vector or reject the request, as shown at block 630. The fetching of the authentication vector or reject the request may be delayed until said another authentication is completed.

In an embodiment, the method 600 may further comprise when said another authentication is performed, sending to a UDR (such as UDR 206), temporary status information for said another authentication indicating that said another authentication is ongoing, so that the temporary status information is stored in the UDR. When said another authentication is completed, the UDM may reset the temporary status information to indicate that said another authentication is completed. The UDM may determine whether the temporary status information indicates that said another authentication is ongoing or not, by checking the temporary status information stored in the UDR.

Although not shown in FIG. 6, the method 600 may further comprises, when there is no another authentication being performed with the HN on the second mobile communication network connection, providing the requested authentication vector to the AUSF node.

In some embodiments, the method 600 may further comprises: when said another authentication is being performed, rejecting the authentication on the first mobile communication network connection, and returning an error code to the AUSF node.

In some embodiments, the method 600 may further comprise: when said another authentication is being performed, holding the authentication on the first mobile communication network connection until said another authentication is finished, without notifying the AUSF node. It's similar to synchronized or blocking API or function pattern.

In some embodiments, the method 600 may further comprise: holding the authentication on the first mobile communication network connection, and sending a response to the AUSF node immediately to inform the AUSF node that said another authentication has not been finished. Meanwhile, the method 600 may further comprises: setting an expected timer in the response. Alternatively, the timer can be set at AUSF node. It's similar to asynchronized or unblocking API or function pattern.

In some embodiments, the method 600 may further comprises: holding the authentication until timeout, and then sending an authentication failure notification with an error code to the AUSF node.

In an embodiment, upon deciding to delay the authentication, the UDM may further set a timer for timing when to end the delaying of the authentication. The timer duration can be an expected end time of the second authentication (which may be determined by the UDM), or can be a predefined value, e.g., as specified in a protocol. Then, the UDM may try to check whether said another authentication is completed when the timer is expired. When it is determined said another authentication is still ongoing while the timer is expired, the UDM may reject the request.

In an embodiment, the method 600 may further comprise upon deciding to delay the authentication, sending a notification to the AUSF node that the authentication on the first mobile communication network connection is to be delayed. For example, the UDM may send a response to the request, and the notification may be contained in the response. Then, the AUSF would know that the authentication has not been finished. A timer for timing when to end the delaying of the authentication may be also set in the response. Alternatively, the timer can be set in the AUSF node.

In an embodiment, upon deciding to reject the authentication, the UDM may send to the AUSF node an error code indicating that the request is rejected because said another authentication is being performed.

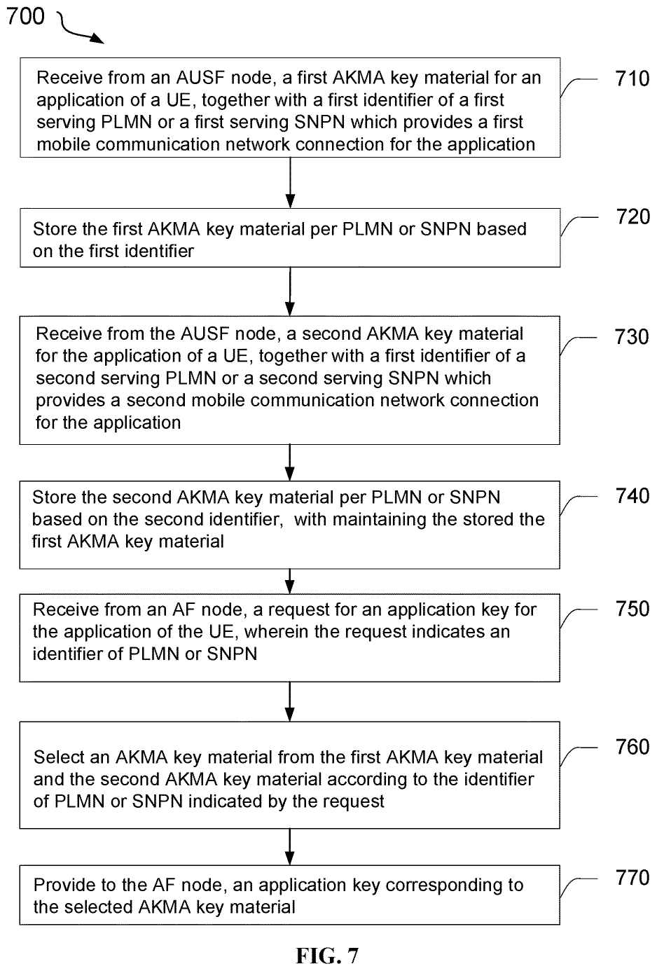

FIG. 7 is a flow chart depicting a method 700 according to embodiments of the present disclosure. The method 700 can be implemented at an authentication and key management for application anchor function node or a network function entity, which may be any suitable communication device. For example, the method 700 may be implemented at the AAnF 407. It can be appreciated that the method 700 may be implemented at other network nodes or devices.

As shown at block 710, the method 700 comprises receiving from an AUSF node, a first AKMA key material for an application of a UE, together with a first identifier of a first serving PLMN or a first serving SNPN which provides a first mobile communication network connection for the application, as shown at block 710; and storing the first AKMA key material per PLMN or SNPN based on the first identifier, as shown at block 720.

The method 700 further comprises receiving from the AUSF node, a second AKMA key material for the application together with a second identifier of a second serving PLMN or a second serving SNPN which provides a second mobile communication network connection for the application, as shown at block 730; and storing the second AKMA key material per PLMN or SNPN based on the second identifier, with maintaining the stored the first AKMA key material, as shown at block 740.

The method 700 further comprises receiving from an AF node, a request for an application key for the application of the UE. The request indicates an identifier of PLMN or SNPN, as shown at block 750; selecting an AKMA key material from the first AKMA key material and the second AKMA key material according to the identifier of PLMN or SNPN indicated by the request, as shown at block 760; and providing to the AF node, an application key corresponding to the selected AKMA key material.

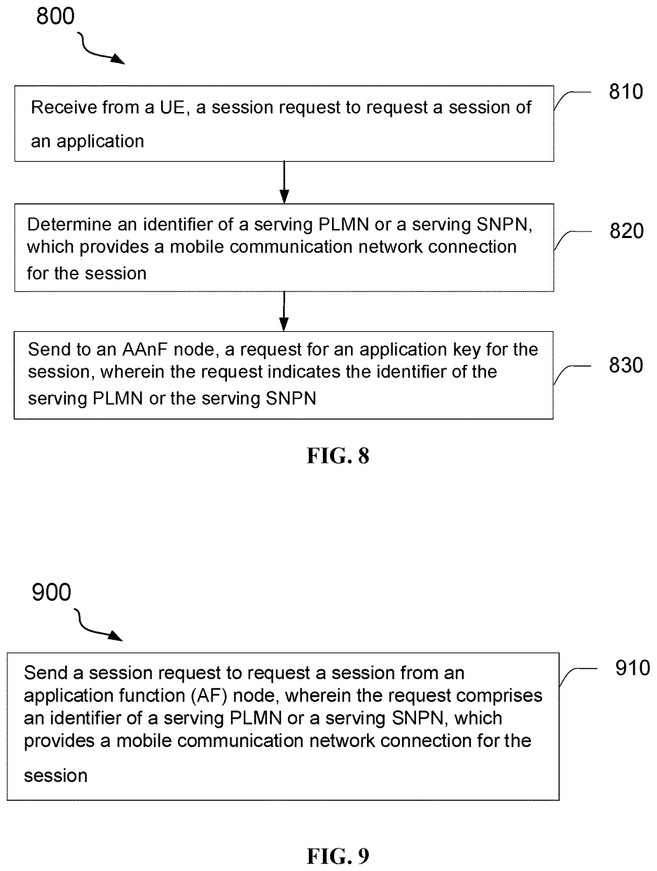

FIG. 8 is a flow chart depicting a method 800 according to embodiments of the present disclosure. The method 800 can be implemented at an application function node or a network function entity, which may be any suitable communication device. For example, the method 800 may be implemented at the AF 408. It can be appreciated that the method 700 may be implemented at other network nodes or devices.

As shown at block 810, the method 800 comprises receiving from a UE, a session request to request a session of an application; determining an identifier of a serving PLMN or SNPN which provides a mobile communication network connection for the session, as shown at block 820; and sending to an AAnF node (such as AAnF 407), a request for an application key for the session. The request indicates the identifier of the serving PLMN or SNPN,

FIG. 9 is a flow chart depicting a method 900 according to embodiments of the present disclosure. The method 900 can be implemented at a UE, which may be any suitable mobile communication device. For example, the method 900 may be implemented at UE 401 as shown in FIG. 4. As shown at block 910, the method 900 comprises sending a session request to request a session from an AF node (such as AF 408). The request comprises an identifier of a serving PLMN or SNPN which provides a mobile communication network connection for the session.

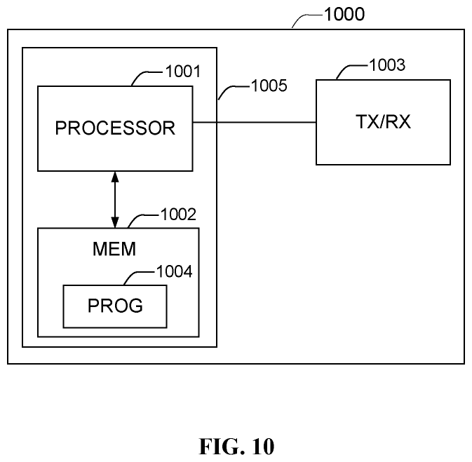

Now reference is made to FIG. 10 illustrating a simplified block diagram of an apparatus 1000 that may be embodied in/as a mobile communication device (such as an interaction sensing UE), or a network node (such as an inaction sensing server). The apparatus 1000 may comprise at least one processor 1001, such as a data processor (DP) and at least one memory (MEM) 1002 coupled to the at least one processor 1001. The apparatus 1000 may further comprise one or more transmitters TX, one or more receivers RX 1003, or one or more transceivers coupled to the one or more processors 1001 to communicate wirelessly and/or through wireline.

Although not shown, the apparatus 1000 may have at least one communication interface, for example, the communicate interface can be at least one antenna, or transceiver as shown in the FIG. 10. The communication interface may represent any interface that is necessary for communication with other network entities.

The processors 1001 may be of any type suitable to the local technical environment, and may include one or more of the following: general purpose computers, special purpose computers, microprocessors, digital signal processors (DSPs) and processors based on multicore processor architecture, as non-limiting examples.

The MEMs 1002 may be of any type suitable to the local technical environment and may be implemented using any suitable data storage technology, such as semiconductor-based memory devices, magnetic memory devices and systems, optical memory devices and systems, fixed memory and removable memory, as non-limiting examples.

The MEM 1002 stores a program (PROG) 1004. The PROG 1004 may include instructions that, when executed on the associated processor 1001, enable the apparatus 1000 to operate in accordance with the embodiments of the present disclosure, for example to perform one of the methods 800 and 900, A combination of the at least one processor 1001 and the at least one MEM 1002 may form processing circuitry or means 1005 adapted to implement various embodiments of the present disclosure.

Various embodiments of the present disclosure may be implemented by computer program executable by one or more of the processors 1001, software, firmware, hardware or in a combination thereof.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosures may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosures may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium, for example, non-transitory computer readable medium, such as a hard disk, optical disk, removable storage media, solid state memory, RAM, etc. As will be appreciated by one of skills in the art, the function of the program modules may be combined or distributed as desired in various embodiments. In addition, the function may be embodied in whole or in part in firmware or hardware equivalents such as integrated circuits, field programmable gate arrays (FPGA), and the like.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, the term “and/or” includes any and all combinations of one or more of the listed terms.

As used herein, the phrase “at least one of A and B” or “at least one of A or B” should be understood to mean “only A, only B, or both A and B.” The phrase “A and/or B” should be understood to mean “only A, only B, or both A and B”.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-65. (canceled)

66. An apparatus comprising:
at least one processor; and
at least one memory storing instructions that, when executed by the at least one processor, cause the apparatus at least to:
receive from a network node, a request to perform an authentication with a home network (HN) of the apparatus on a first mobile communication network connection of the apparatus;
determine whether there is another authentication being performed with the HN on a second mobile communication network connection for the apparatus or not; and
when there is another authentication being performed with the HN on the second mobile communication network connection, delay the authentication on the first mobile communication network connection or reject the request.

67. The apparatus according to claim 66, wherein when the instructions are executed by the at least one processor, further cause the apparatus at least to:
when there is no another authentication being performed with the HN on the second mobile communication network connection, perform the authentication on the first mobile communication network connection.

68. The apparatus according to claim 66, wherein when the instructions are executed by the at least one processor, further cause the apparatus at least to delay the authentication on the first mobile communication network connection by:
delaying the authentication on the first mobile communication network connection, until said another authentication is completed.

69. The apparatus according to claim 66, wherein when the instructions are executed by the at least one processor, further cause the apparatus at least to delay the authentication on the first mobile communication network connection by:
sending to the network node, a notification to inform the HN that the authentication on the first mobile communication network connection is to be delayed.

70. The apparatus according to claim 66, wherein when the instructions are executed by the at least one processor, further cause the apparatus at least to delay the authentication on the first mobile communication network connection by:
setting a timer for timing when to end the delaying of the authentication.

71. The apparatus according to claim 70, wherein when the instructions are executed by the at least one processor, further cause the apparatus at least to:
reject the request when it is determined said another authentication is still ongoing while the timer is expired.

72. The apparatus according to claim 66, wherein when the instructions are executed by the at least one processor, further cause the apparatus at least to reject the request by:
sending an error code to the network node, indicating that the request is rejected because said another authentication is being performed.

73. The apparatus according to claim 66, wherein when the instructions executed by the one or more processors, further cause the apparatus at least to:
when said another authentication is performed, set in the apparatus, an indication of authentication status to indicate that said another authentication is ongoing.

74. The apparatus according to claim 73, wherein when the instructions executed by the one or more processors, further cause the apparatus at least to:
when said another authentication is completed, reset the indication of authentication status to indicate that said another authentication is completed.

75. The apparatus according to claim 73, wherein when the instructions are executed by the at least one processor, further cause the apparatus at least to:
check the indication of authentication status to determine whether said another authentication is ongoing or not.

76. The apparatus according to claim 73, wherein the indication of authentication status is maintained in a mobility management sublayer of the apparatus.

77. The apparatus according to claim 66, wherein the authentication for the first mobile communication network connection is triggered by a network node in the HN, while said another authentication for the second mobile communication network connection is triggered by the apparatus.

78. The apparatus according to claim 66, wherein the request is an authentication and key agreement (AKA) challenge from an authentication server function (AUSF) node of the HN for a primary authentication on the first mobile communication network connection.

79. The apparatus according to claim 78, wherein delaying the authentication on the first mobile communication network connection comprises: delaying using the AKA challenge to generate a key KAUSF of the authentication.

80. The apparatus according to claim 66, wherein the HN is a home public land mobile network or a subscribed standalone non-public network (SNPN).

81. A method performed at a user equipment (UE), the method comprising:
receiving from a network node, a request to perform an authentication with a home network (HN) of the UE on a first mobile communication network connection of the UE;
determining whether there is another authentication being performed with the HN on a second mobile communication network connection for the UE or not; and
when there is another authentication being performed with the HN on the second mobile communication network connection, delaying the authentication on the first mobile communication network connection or reject the request.

82. An apparatus implemented at a user equipment (UE), the apparatus comprising:
at least one processor; and
at least one memory storing instructions that, when executed by the at least one processor, cause the apparatus at least to:
send a session request to request a session from an application function (AF) node, wherein the request comprises an identifier of a serving public land mobile network (PLMN) or a serving standalone non-public network (SNPN), which provides a mobile communication network connection for the session.
